(19) United States
(12) Patent Application Publication
(10) Pub. No.: US 2026/0261187 A1
(43) Pub. Date: Sep. 3, 2026

(54) Inverter for an Ultra-Light Motor Drive

(71) Applicant: Massachusetts Institute of Technology, Cambridge, MA (US)

(72) Inventors: James L. Kirtley, Lake Worth, FL (US); Jeffrey H. Lang, Sudbury, MA (US); David M. Otten, Newton, MA (US); David J. Perreault, Cambridge, MA (US); Mohammad Mowafaq Qasim, Cambridge, MA (US); Zoltan Sandor Spakovszky, Watertown, MA (US)

(73) Assignee: Massachusetts Institute of Technology, Cambridge, MA (US)

(21) Appl. No.: 19/163,096

(22) PCT Filed: May 9, 2024
(86) PCT No.: PCT/US2024/028539

§ 371 Date: Sep. 8, 2025

Related U.S. Application Data
(60) Provisional application No. 63/500,985, filed on May 9, 2023.

(51) Int. Cl. H02K 11/33; H02K 7/00; H02K 9/06; H02P 21/22; H02P 27/08

(52) U.S. Cl. CPC H02K 11/33; H02K 7/006; H02K 9/06; H02P 21/22; H02P 27/08; H02K 2211/03

(57) ABSTRACT

Described herein is a design and optimization of a 1-MW inverter for a high-speed, high-specific-power motor drive. In some embodiments, an inverter system includes ten 100-kW inverter sets distributed around the periphery of the machine to drive ten separate sets of three-phase open-ended windings. Each inverter set includes three single-phase full-bridge inverters each of which drives an open-ended phase winding. The use of three single-phase full-bridge inverters for each inverter can yield an improved specific power as compared to either the three-phase bridge inverter or the active neutral-point clamped (ANPC) inverter in target applications. Disclosed inverter systems may be used with a 1-MW permanent magnet machine and associated thermal management system.

### CROSS-REFERENCE TO RELATED APPLICATIONS

This application claims the benefit under 35 U.S.C. § 119 of U.S. Provisional Patent Application No. 63/500,985 filed on May 9, 2023, which is hereby incorporated by reference herein in its entirety.

### STATEMENT REGARDING FEDERALLY SPONSORED RESEARCH

N/A

### BACKGROUND

The design of light and efficient MW-class high-speed motor drives for aircraft applications is presently receiving considerable attention. Advances in the specific power (i.e. power-to-mass ratio or active-mass power density) of such motor drives including their power electronics are central to the future of hybrid and fully-electric aircraft.

### SUMMARY

Some of the state-of-the-art research in MW-class high-specific-power inverters for light and efficient MW-class high-speed motor drives, including converters described in the present disclosure, is summarized in Table 1.

TABLE 1
Megawatt-class, high-power-density converters for aircraft propulsion applications

| | | | | | | | Present | |
|---|---|---|---|---|---|---|---|---|
| | GE | | Nottingham | | UTK | | Disclosure | |
| Rated Power | 1 | MW | 4 | MW | 1 | MW | 1 | MW |
| Machine | Single three- | | 8x isolated | | Single wye- | | 10x, 3x | |
| winding | phase | | wye-connected | | connected | | separate | |
| | winding^{†} | | three-phase | | three-phase | | single-phase | |
| | | | windings | | winding | | windings | |
| DC bus voltage | 2.4 | kV_{dc} | 3 | kV_{dc} | 1 | kV_{dc} | 720 | V |
| AC phase | 1650 | Vᵣₘₛ | 404 | Vᵣₘₛ | 388 | Vᵣₘₛ | 480 | Vᵣₘₛ |
| voltage | | | | | | | | |
| Topology | 3L-ANPC^{‡} | | 8x 3L-ANPC | | 2 Interleaved | | 10x | |
| | | | | | 3L-ANPC | | 3x Full- | |
| | | | | | | | bridge | |
| Switch Tech. | Si IGBT + SiC | | Si IGBT | | SiC | | SiC | |
| Packaging | power | | power | | power | | discrete | |
| | modules | | modules | | modules | | | |
| Machine's fund. | 1.4 | kHz | 1 | kHz | 3 | kHz | 2.083̅ | kHz |
| elect. frequency | | | | | | | | |
| Device | 20 | kHz | 15 | kHz | 60 | kHz | 80 | kHz |
| switching freq. | 14.286 | | 15 | | 20 | | 38.4 | |
| Carrier ratio | | | | | | | | |
| Cooling | Water-cooled | | Liquid-cooled | | Cryogenically- | | Air-cooled | |
| | | | | | cooled | | | |
| | | | | | (nitrogen | | | |
| | | | | | liquid/gas) | | | |
| Specific power | 15 | kW/kg | 16.6 | kW/kg | 18 | kVA/kg | 53 | kW/kg^{§} |

| Efficiency | 99.1% | 98.5% | 98.5% | >98% |
|---|---|---|---|---|
| Test Status | Verified (1 | Partially | Verified (1 | Partially |
| | MW) | verified (1 | MVA) | verified |
| | | MW) | | (inductive |
| | | | | test) |
| SP Calc. | Incl. structure, | Excl. structure, | Excl. | Incl. boards |
| (kW/kg) | excl. coolant + | coolant + HEX | enclosure, | (FIG. 1), |
| | heat- | | coolant + | excl. cooling |
| | exchanger | | HEX weights | fans + |
| | (HEX) | | | enclosure |

The following notes apply to Table 1.
^{†}The test motor three-phase winding configuration, wye or delta-connected, is not provided.
^{‡}Three-level Active Neutral Point Clamped (3L-ANPC)
^{§}The anticipated specific power is 38 kW/kg when the weight of the 30 boards and air-cooling source are considered, while excluding the enclosure. When the enclosure is included and air-cooling source is excluded, the anticipated specific power is 27 kW/kg. When all components are taken into account in the test setup for one 100-kW full-bridge inverter set, including the air-cooling source and structure, the calculated specific power is 22 kW/kg. It is worth mentioning that neither the air-cooling source nor the enclosure in the test setup were optimized for weight; they were solely used for preliminary testing purposes.

This disclosure is generally directed to a design and optimization of a power conversion system for a 1-MW motor drive, with an inverter and electric machine co-optimized. A topology comparison of two-level and three-level inverters is provided. It is found that while three-phase multilevel inverters can achieve the highest efficiency, they are heavier than two-level inverters under equal ripple requirement. Moreover, single-phase full-bridge inverters for each phase are found to provide the lightest weight in this design owing to the high fundamental output frequency. Accordingly, disclosed embodiments of a motor drive are based on sets of single-phase full-bridge inverters driving independent phase windings of the three-phase machine.

According to some aspects of the disclosure, a three-phase machine stator comprises ten sectors, each sector comprising three separate (open-ended) single-phase windings spanning a pole pair of a ten-pole-pair 1-MW permanent magnet machine. In some embodiments, the machine may have a design taken from “Design and manufacturing of a high specific power electric machine for aircraft propulsion” by Spakovszky et. al., 2023 AIAA/IEEE Electric Aircraft Technologies Symposium (EATS), 2023. Accordingly, a distributed power conversion system comprising ten 100-kW inverter sets can be provided, with each inverter set comprising three single-phase full-bridge converters with their dc inputs closely coupled. Each inverter set drives the three separate phase windings in a sector of the machine. The general concepts, structures, and techniques disclosed herein can be applied to other electric machines, and the number and size of inverter sets can be varied accordingly.

While embodiments of the present disclosure may be described in the context of electrified airplane propulsion, the general concepts, structures, and techniques disclosed herein are not so limited and may find use in various other applications.

According to one aspect of the disclosure, an inverter system for a high-power three-phase electric machine includes a plurality of inverter sets each having three single-phase full-bridge inverters and configured to drive a three-phase set of open-ended phase windings of the electric machine.

In some embodiments, the electric machine comprises a 1-MW motor. In some embodiments, for at least one of the plurality of inverter sets, the three single-phase full-bridge inverters have a dc bus tightly electrically coupled to provide cancellation of twice-machine-frequency energy pulsation. In some embodiments, the inverter sets are distributed along a circumference of the electrical machine.

In some embodiments, each inverter of each of the plurality of inverter sets has ac output arranged to be connected to a separate one of the open-ended phase windings of the electric machine using a pair of terminal leads, wherein all said terminal leads are approximately of equal length. In some embodiments, the equal length of all said terminal leads is between six (6) and eight (8) inches. In some embodiments, each of the inverter sets is configured to connect to the electric machine along a coaxial direction. In some embodiments, the inverter sets are arranged to permit air flow in the coaxial direction.

In some embodiments, for at least one of the plurality of inverter sets, the three single-phase full-bridge inverters each have local processors with phase-locked clocks. In some embodiments, the clocks of the three single-phase full-bridge inverters are phase-locked with each other. In some embodiments, the inverter system further includes a master controller configured to control each of the plurality of inverter sets, wherein the clocks are phase-locked with the master controller. In some embodiments, the system further includes an interconnect-multiplexer board configured to provide communication between the master controller and particular ones of the plurality of inverter sets. In some embodiments, at least one of the inverter sets has its three single-phase full-bridge inverters connected in a daisy-chain arrangement using serial-peripheral interface (SPI).

In some embodiments, the electric machine has a stator with a plurality of sectors, wherein different ones of the plurality of inverter sets are configured to drive different one of the plurality of stator sectors. In some embodiments, at least one of the single-phase full-bridge inverters comprises a plurality of field-effect transistors (FETs) and a corresponding plurality of gate driver circuits. In some embodiments, each of the gate drivers is located over a copper plane having the same voltage as source pins of a respective one of the plurality of FETs. In some embodiments, the plurality FETs are arranged in a double-sided layout, with high-side and low-side FETs placed on opposite sides of a printed circuit board. In some embodiments, the at least one of the single-phase full-bridge inverters includes one or more temperature sensors attached to one or more FETs of the plurality. In some embodiments, the inverter system further includes a dc bus ring to provide dc supply to the plurality of inverter sets.

According to another aspect of the disclosure, an inverter set for a high-power three-phase motor comprises three single-phase full-bridge inverters configured to drive a three-phase set of open-ended phase windings of the motor, the three single-phase inverters have a dc bus tightly electrically coupled to provide cancellation of twice-fundamental-frequency energy pulsation.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

### BRIEF DESCRIPTION OF THE DRAWINGS

The manner of making and using the disclosed subject matter may be appreciated by reference to the detailed description in connection with the drawings, in which like reference numerals identify like elements.

FIG. 1 is a block diagram illustrating a turboelectric propulsion system in which embodiments of the present disclosure may be employed.

FIG. 2A is an isometric view of an illustrative high power density electric machine which can be driven using disclosed power inverter embodiments.

FIG. 2B is a front view of the electric machine of FIG. 2A.

FIG. 2C is a close-up view showing one sector of the electric machine of FIG. 2A that can be driven by one set of three single-phase full-bridge inverters.

FIG. 3 is a cutaway view of a one 1-MW motor drive comprising an inverter system, electric machine, super structure, and cooling airflows, according to some embodiments.

FIG. 4A is a side view of an air-cooled 1-MW inverter system based on distributed power conversion, according to some embodiments.

FIG. 4B is a top (axial) view of the inverter system of FIG. 4A.

FIG. 4C is a rear view of a power electronics aluminum housing with the rear cover open.

FIG. 5A is a schematic view of an inverter topology utilizing a set of three single-phase full-bridge inverters driving a machine with open-ended windings.

FIG. 5B is a schematic view of an inverter topology utilizing a three-phase bridge inverter driving a machine with delta-connected winding.

FIG. 5C is a schematic view of an inverter topology utilizing a three-phase active neutral-point clamped (ANPC) inverter powering a machine with delta-connected winding.

FIGS. 6A-C are charts showing simulated phase current waveforms and phase-A voltage/current waveforms for the inverter topologies of FIGS. 5A-C, respectively.

FIG. 7 is a chart showing total loss versus total mass for the 1-MW inverters of FIGS. 5A-C.

FIG. 8 is a chart showing total loss versus normalized semiconductor device area per physical switch position for the 1-MW distributed full-bridge inverter of FIG. 5A.

FIG. 9A is a first (high-side field-effect transistor (FET)) view of a single-phase full-bridge inverter board, according to some embodiments.

FIG. 9B is a second (showing a low-side FET) view of the inverter board of FIG. 9A.

FIG. 9C is a top view of a full-bridge inverter set comprising three inverter boards as in FIGS. 9A and 9B, according to some embodiments.

FIG. 10 is a block diagram illustrating overall control of a full-bridge inverter set, according to some embodiments.

FIG. 11 is a block diagram showing a control architecture for a 1-MW machine, according to some embodiments.

FIG. 12 is a diagram illustrating a phase-locked loop routine that can be used for control of a 1-MW machine.

The drawings are not necessarily to scale, or inclusive of all elements of a system, emphasis instead generally being placed upon illustrating the concepts, structures, and techniques sought to be protected herein.

### DETAILED DESCRIPTION

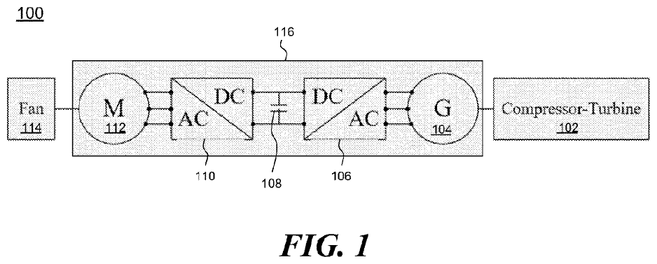

FIG. 1 shows a turboelectric propulsion system 100, such as in a drive train configuration of a hybrid electric aircraft. Illustrative system 100 includes a compressor 102, a generator 104, a rectifier 106, a dc source 108, an inverter 110, a motor 112, and a fan 114. The generator 104, rectifier 106, dc source 108, inverter 110, and motor 112 collectively form an electric drivetrain 116 of the system 100.

The compressor 102 and generator 104 can be integrated. For example, the rotor element of the generator 104 can be integrated with the mechanical rotating part of the compressor 102, which is driven by a gas-turbine-combustion system. The combustor-driven turbine turns the compressor 102 which in turn drives the integrated generator 104. The output of the generator 104 is rectified and supplies power to the dc source 108. The dc source 108 may be a battery or capacitor. Power from the dc source 108 is used to drive motor 112 through inverter 110. The motor in turn drives fan 114.

The feasibility and sustainability of electrified propulsion rely on the advancement of key components, such as batteries, power electronics, and electric machines, aiming for significant weight reduction and efficiency gains. This disclosure is generally directed to enhancing the specific power of the power electronics of the electric drivetrain 116 and, more particularly, to the design and optimization of a 1-MW power converter system that can be employed as either an inverter (converting DC to AC electric power) or a rectifier (converting AC to DC electric power), depending on how the semiconductor devices are controlled.

There are other forms of hybrid turbo-electric configurations in which disclosed MW-class machine drives can be applied, including parallel, series, parallel/series hybrid electric (which uses energy storage), or all-electric (no fuel-based turbine), in which there is a large battery or energy storage that supplies power to a motor drive (inverter plus electric motor), which in turn runs a fan in an aviation system.

While certain embodiments of the present disclosure are described in terms of inverter systems (converting DC to AC electric power), it should be understood that these systems can be operated as a rectifier (converting AC to DC electric power), depending on how the semiconductor devices are controlled. That is, disclosed inverter systems can be generally viewed as power conversion systems.

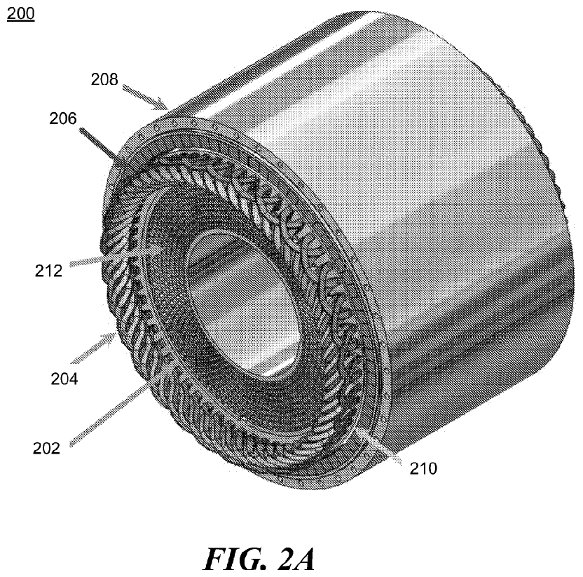

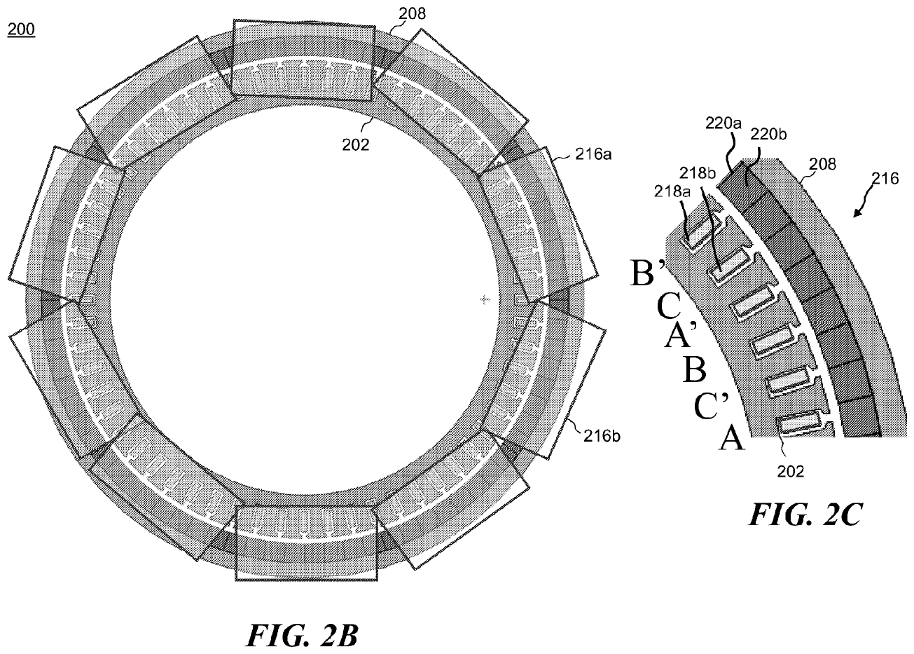

FIGS. 2A-C show a high-power density electric machine 200 which can be driven using disclosed power inverter embodiments. The electric machine 200 includes a stator core 202 wound with Litz wire 204 and a Halbach array of rotor magnets 206 retained within a light-weight rim 208 (e.g., a titanium rim). An airgap 210 may be provided between the stator and rotor. A channel-type heatsink 212 may be provided to enable air-cooling at full power.

The Halbach array rotor eliminates the need for magnetic material in the rotor (e.g., eliminates the need for rotor laminations). Within the Halbach array, four directions of magnetization may be used per pole to decrease the harmonic distortion of the airgap flux density and reduce torque ripple (e.g., to 1% of the average torque). In some cases, iron-cobalt stator laminations (e.g., 0.1 mm laminations) and Litz wire may be used to mitigate core loss and ohmic loss at the high operational electrical frequency.

As seen in FIG. 2B, electric machine 200 can include ten (10) sectors 216a, 216b, etc. (216 generally, sometimes referred to as “pole pairs”). As best seen in FIG. 2C, each sector 216 can span six (6) stator slots 218a, 218b, etc. and eight (8) rotor magnet segments 220a, 220b, etc. of a 60-slot stator, and 80-magnet-segment Halbach rotor. Each sector 216 can have a group of three open-ended single-phase windings comprising a three-phase set (A, B, C) that can be driven by one set of three single-phase full-bridge inverters.

A modular, single-phase winding pattern may be used to improve reliability and allow the use of single-phase inverter drives, such as those disclosed herein.

The electric machine 200 design is taken from taken from “Design and manufacturing of a high specific power electric machine for aircraft propulsion” by Spakovszky et. al., 2023 AIAA/IEEE Electric Aircraft Technologies Symposium (EATS), 2023.

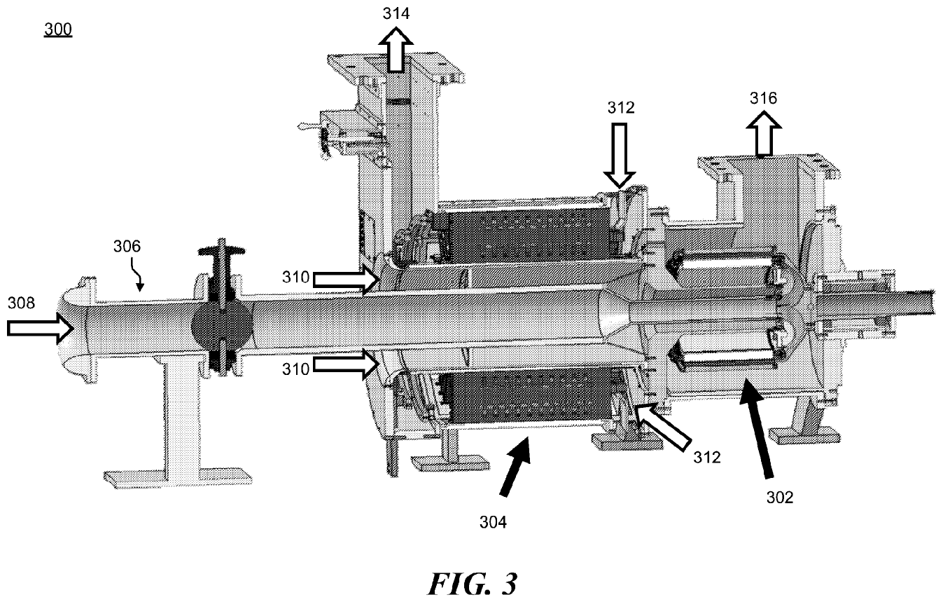

FIG. 3 shows a 1-MW motor drive 300 in which disclosed inverter systems can be employed. Illustrative motor drive 300 includes an electric machine 302 and power electronics 304. Power electronics 304 can include, for example, a dc ring bus, multiple sets (e.g., 10 sets) of three single-phase full-bridge inverters with tightly-coupled dc inputs, and an interconnect-multiplexer board, among other electronics. A master control board (sometimes referred to as a central controller) can be inside or outside the power electronics enclosure housing, while the multiplexer board may be located inside the enclosure in close proximity with the inverter sets to reduce length of communication cables between the inverter boards and the multiplexer board and thus further assist in mitigating noise, improve signal integrity for reliable operation of the inverters at high voltage and high dv/dt.

The dc bus is configured to distribute a dc supply voltage/current across all inverters in the system and may, for example, comprise two metal rings electrically coupled to respective positive and negative terminals of a dc input port of each inverter.

The interconnect-multiplexer board enables communication between a master control board and individual inverters or inverter sets. For example, the interconnect-multiplexer board can enable the master control board to distribute commands to the “phase-A” inverter board in a particular inverter set. Furthermore, the multiplexer board may interface enable/disable signals and monitoring sensor signals between a single-phase inverter board and the master control board. In some examples, the interconnect-multiplexer board may be ring-shaped and sized to fit inside the ring-shaped dc bus (e.g., in a concentric arrangement).

The electric machine 302 and power electronics 304 can be housed within a superstructure 306 designed to permit airgap airflow 308, heatsink airflow 310, power electronics airflow 312, power electronics exhaust 314, and motor exhaust 316. Electric machine 302 may be the same as or similar to that shown in FIGS. 2A-C.

With the motor drive design of FIG. 3, the electric machine is of an outer-rotor morphology and the rotor is supported mechanically from one side in an overhung manner. This facilitates cooling the machine from the other side (that is not overhung), by providing air-cooling flow via tube(s) that passes through the hollow part of the machine, which is located on its inner diameter, thus allowing air-cooling for all its parts including the machine's heatsink, airgap, front and aft end turns. The power electronics' air-cooling flow on the other hand is accessed via inlet chambers in which the air is sucked radially into each sector or a set of three single-phase full-bridge inverters of the power electronics housing.

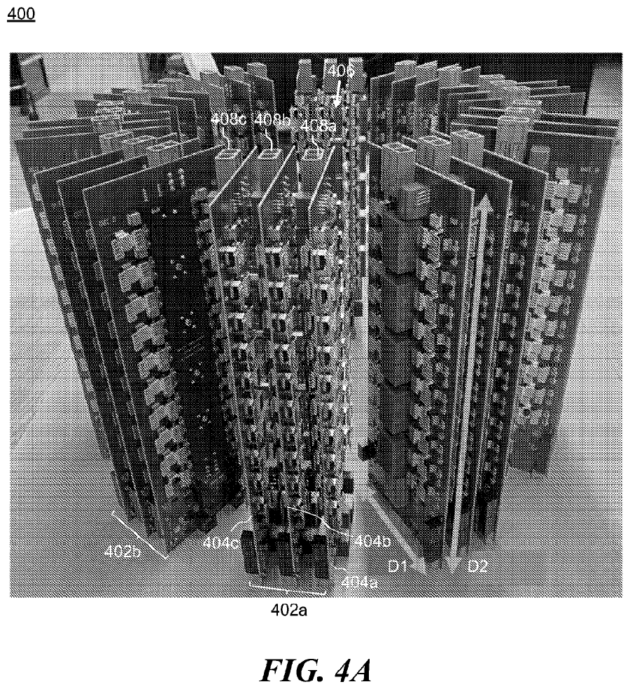

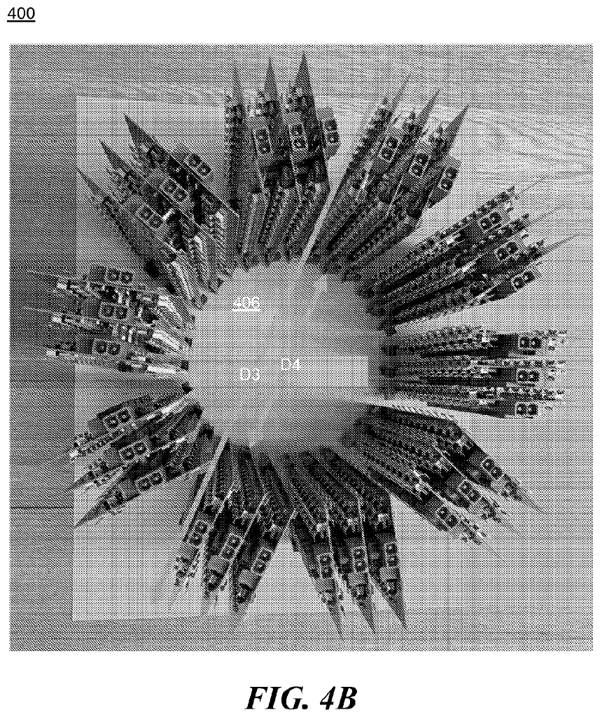

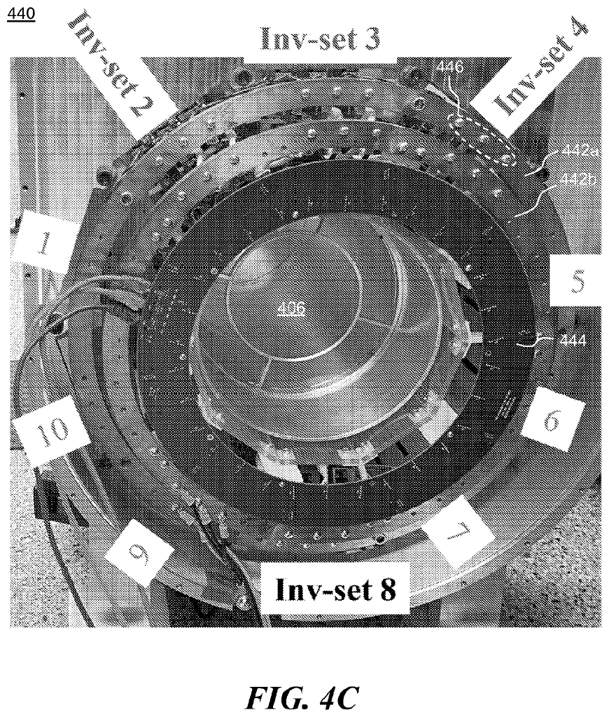

FIGS. 4A and 4B show an example of a 1-MW distributed power converter system 400. As shown, ten (10) inverter sets 402a, 402b, etc. (402 generally) can each have three (3) single-phase full-bridge inverters with tightly-coupled dc inputs. For example, inverter set 402a has inverters 404a, 404b, 404c (404 generally). The inverter sets 402 can be arranged radially in a decagonal pattern forming an inner cavity 406 for air cooling of the electric machine.

Power converter system 400 may be arranged coaxially with, and in close proximity to, a 1-MW electric machine, such as illustrated in FIG. 3. Each inverter set 402 can be connected to drive a sector of an electric machine. Thus, for example, the ten-inverter-set embodiment of FIGS. 4A and 4B may be used to drive a machine having ten separate sectors, where each sector includes of a group of three open-ended single-phase windings. In more detail, using inverter set 402a as an example, each single-phase inverter 404a-c can be connected to an open-ended single-phase winding in a group via its respective ac output port 408a-c. In general, the number of inverter sets 402 may be selected to equal the number of pole pairs or sectors of the electric machine being driven. For example, an inverter system may include eight (8) or twelve (12) inverter sets instead of ten (10) if electric machine's number of pole pairs (or sectors) are equal to eight (8) or twelve (12), respectively. Furthermore, the number of inverter sets and/or sectors of the electric machine are not restricted to the number of pole pairs of the machine. In some examples, the number of inverter sets can be equal to the number of poles or a divisible fraction of the number of poles, not necessarily limited to the number of stator pole pairs.

Each ac output ports 408a-c (sometimes referred to as “terminals”) can be connected to the electric machine via a pair of terminal leads, which may all be approximately equal length. In some cases, these terminal leads may have a length between six (6) and eight (8) inches. Of note, the inverter dc input ports can be located on the opposite end from the ac output ports and thus are not visible in FIGS. 4A and 4B.

As illustrated in FIG. 4A, each inverter 404 can have a width D1 and a height D2. As illustrated in FIG. 4B, power converter system 400 can have an outer diameter D3 and an inner diameter D4 corresponding to the diameter of cavity 406. In some examples, D1 may be approximately 5″, D2 may be approximately 13.8″, D3 may be approximately 21.4″, and/or D4 may be approximately 10.5″.

The distributed conversion approach disclosed herein offers a number of advantages over existing converters, including improved weight and efficiency, simplified packaging and cooling, modularity and maintainability, and the flexibility to integrate the power electronics closely with the electric machine. The inverter sets 402 can be co-optimized with the electric machine and their respective thermal management systems to maximize the specific power of the overall 1-MW system. Furthermore, the distributed conversion system is air-cooled (by axial air flow), leveraging the abundance of cooling air available in the system. The 1-MW power converter system 400 can provide specific power of 53 kW/kg (which may be favorably compared with other state-of-the-art high-power inverters, as shown in Table 1).

The performance of the three-phase bridge inverter has been compared to a group of three single-phase full-bridge inverters for motor drive applications. It was found that for a given semiconductor device area and equal rms phase current ripple, separate full-bridge inverters may be preferable for designs in which switching losses are dominant, whereas three-phase inverters may be preferable for designs in which conduction losses are dominant. Individual phase drive is thus desirable in applications requiring high switching frequencies, as in high-speed low-inductance machines.

FIG. 4C shows a power electronics aluminum housing 440 with the rear cover open, illustrating 1-MW dc bus rings 442a, 442b (+DC,−DC) and an interconnect-multiplexer board 444. As shown, each of the three full-bridge inverter boards in a 3-phase set (e.g., “Inv-set 4”) may be electrically connected at their individual +DC and −DC through two short leads to dc bus rings 442a, 442b, connected with screws 446. In some examples, the short leads can be flexible wires. In other examples, they can be short copper bars. The dc short leads can have a length in the range of from 1.5 to 3 inches, for example. As shown, interconnect-multiplexer board 444 may also have a circular shape and be positioned within the bus rings 442a, 442b in a concentric arrangement. The air flow cavity 406 is also visible in FIG. 4C.

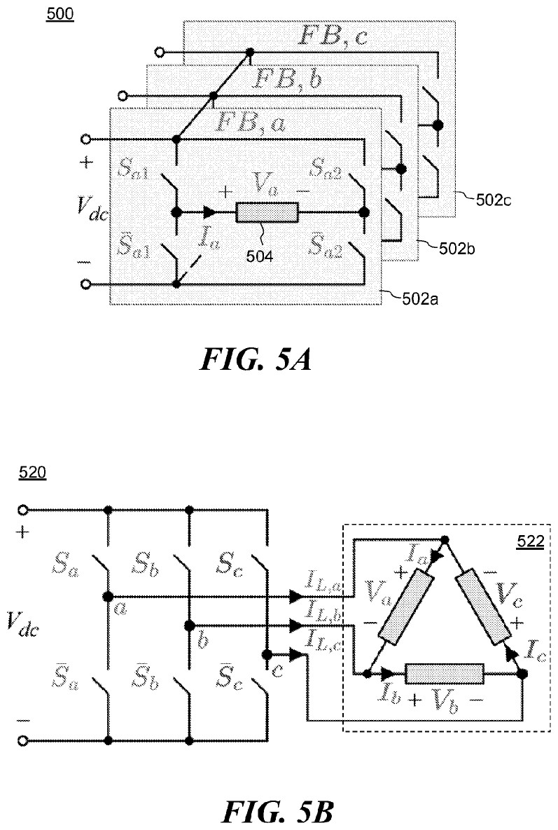

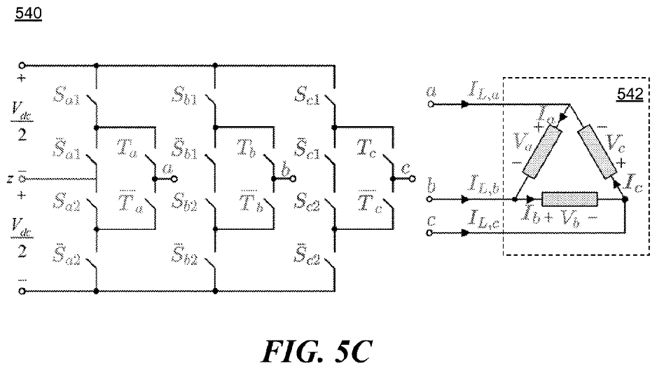

Turning to FIGS. 5A-C, it may be desirable to design a 1-MW drive so as to maximize its specific power (including the weight of the electric machine, power electronics and thermal management system) while maintaining adequate efficiency and cooling. To achieve this, an efficiency-weight comparison can be performed considering inverter sets based on two-level topologies as well as a multilevel topology that is often favored in this application. Specifically, the three topologies are: (a) a group of three full-bridge inverters driving a machine with open-ended windings (FIG. 5A); (b) a three-phase bridge inverter driving a machine with delta-connected windings (FIG. 5B); and (c) a three-phase, three-level active neutral-point clamped (ANPC) inverter driving a machine with delta-connected windings (FIG. 5C). Of note, the particular phase winding configuration for three-phase inverters is not fundamental to the inverter comparison, but avoids rescaling machine turns between the three-phase bridge inverter and single-phase inverters.

FIG. 5A shows an inverter topology 500 having a set of three (3) single-phase full-bridge inverters 502a-c (502 generally). Each inverter 502 can have a plurality of switches arranged to selectively connect the two ends of a single-phase winding to a dc voltage, V_{dc}. For example, inverter 502a has a single-phase winding 504 and four (4) switches Sₐ₁, S̅ₐ₁, Sₐ₂, and S̅ₐ₂, with first end of winding 504 connected between series-connected switches Sₐ₁, S̅ₐ₁ and a second end of winding 504 connected between series-connected switches Sₐ₂, S̅ₐ₂.

FIG. 5B shows a three-phase bridge inverter topology 520 for driving a machine with delta-connected windings. Topology 520 includes six (6) switches Sₐ, S̅ₐ, S_{b}, S̅_{b}, S_{c}, and S̅_{c}, and a three-phase delta connected winding 522. As shown, winding 522 has three (3) nodes, with a first node connected between series-connected switches Sₐ, S̅ₐ, a second node connected between series-connected switches S_{b}, S̅_{b}, and a third node connected between series-connected switches S_{c}, S̅_{c}.

FIG. 5C shows a three-phase ANPC inverter topology 540 for powering a machine with delta-connected windings. Topology 540 includes sixteen (16) switches Sₐ₁, S̅ₐ₁, Sₐ₂, S̅ₐ₂, Tₐ, T̅ₐ, S_{b1}, S̅_{b1}, S_{b2}, S̅_{b2}, T_{b}, T̅_{b}, S_{c1}, S̅_{c1}, S_{c2}, S̅_{c2}, T_{c}, and T̅_{c} arranged as shown to provide three outputs a, b, c along. A three-phase delta connected winding 542 has three (3) nodes each connected to a different one of three switching network outputs a, b, c.

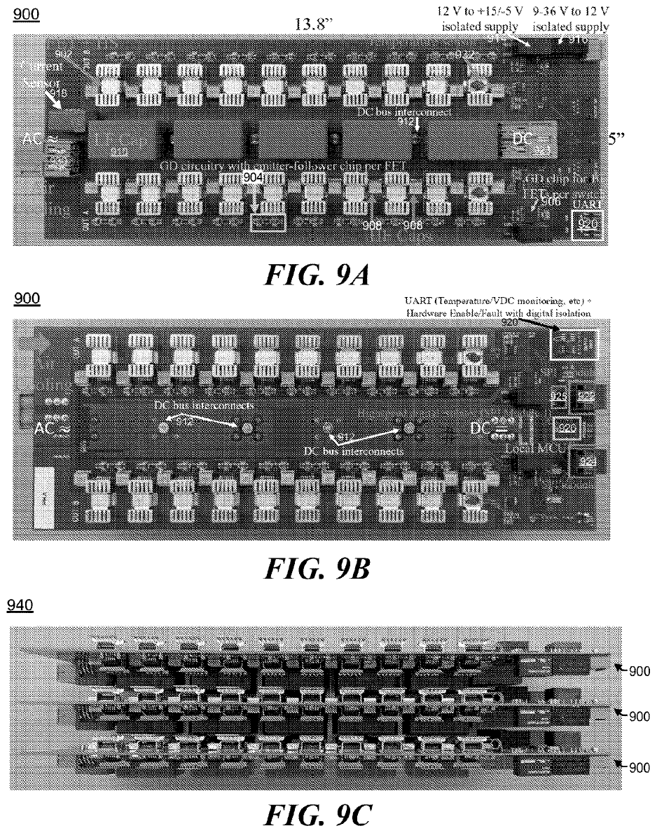

In hardware implementations of the illustrated topologies, such as the implementation of FIG. 9A, capacitors can be connected between the Vdc+ to Vdc− terminals at the input (left-hand) side of each inverter topology. In some cases, capacitors can be located next to switches (e.g., FETs) for improved performance.

As detailed herein, the topology comparison reveals that even though multilevel inverters may achieve higher efficiency, they may be significantly heavier in weight (e.g., due to the number of FETs and high-frequency capacitors required). By comparison, groups of single-phase full-bridge inverters can achieve the lightest weight and the second highest efficiency of the three considered options. Thus, in some embodiments, inverter topology 500 of FIG. 5B may be implemented by each of the inverter sets 402 of FIG. 4A.

TABLE 2
1-MW permanent magnet machine design specifications
(used as an example for the topology comparison)

| | | Pole pairs | | | RMS |
|---|---|---|---|---|---|
| | | (# of | | | current |
| | | multiphase | Output | Mod. | ripple |
| Power | Speed | windings) | frequency | index | ratio |
| 1 MW | 12500 rpm | 10 | 2083.3̅ Hz | 0.927 | 2.7% |

| | | | | Terminal | | | | Output |
|---|---|---|---|---|---|---|---|---|
| | | | | inductance | | Back-emf | Phase | phase |
| | Winding | DC bus | | Terminal | | voltage | current | voltage |
| Topology | config. | voltage | | resistance | | (Fund.) | (Fund.) | (Fund.) |
| 3-phase | 3-phase | 720 | V | 116.6 | μH | 455.3 Vᵣₘₛ | 73.5 Aᵣₘₛ | 472 Vᵣₘₛ |
| bridge | delta | | | 42.4 | mΩ | (643.9 Vₚ) | (104 Aₚ) | (667.5 Vₚ) |
| Full- | 3x single- | 720 | V | 116.6 | μH | 455.3 Vᵣₘₛ | 73.5 Aᵣₘₛ | 472 Vᵣₘₛ |
| bridge | phase | | | 42.4 | mΩ | (643.9 Vₚ) | (104 Aₚ) | (667.5 Vₚ) |
| 3-phase | 3-phase | 1200 | V | 324 | μH | 758.9 Vᵣₘₛ | 44.1 Aᵣₘₛ | 786.7 Vᵣₘₛ |
| ANPC | delta | | | 117.9 | mΩ | (1073.3 Vₚ) | (62.4 Aₚ) | (1112.6 Vₚ) |

To compare the three inverter topologies, a 1-MW machine with sets of three-phase-connected windings or three open-ended windings can be used as the load (Table 2). In particular, the machine can have ten (10) electrically-separate sectors, each sector consisting of a group of three open-ended single-phase windings comprising a three-phase set, or a set of three-phase delta-connected windings. The 1-MW inverter system can be divided into ten 100-kW three-phase inverters based on one of the considered inverter topologies in FIGS. 5A-C, with each of the ten inverter units driving a sector of the machine. Performance comparisons among inverters can be made based on a specified rms phase current ripple percentage (e.g. 2.7%) to impose identical high-frequency losses in the machine. In some cases, different switching frequencies may be used for different topologies.

Different semiconductor devices can be selected for use within an inverter topology (e.g., for the switches in FIGS. 4A-C), such as GaN (Gallium nitride) discrete devices, SiC (Silicon carbide) discrete devices, and SiC power modules. In some embodiments, an inverter may be implemented using the 1200-V SiC C3M0075120J MOSFET. This device may offer the highest performance among available devices and modules for a 1-MW system design.

The following assumptions can be made when comparing inverter topologies. The total loss of each of the respective 1-MW inverters includes the losses of FETs, gate drivers, and high-frequency capacitors, while the total mass includes the total weight of FETs, gate drivers, high-frequency capacitors, circuit boards, and heatsink. A heatsink with a mass-loss ratio of 0.634 kg/kW can be considered in the topology comparison. The gate driver chips can be assumed to have half the footprint area as the FETs. The weight of the printed circuit boards (PCB mass denoted as M_{PCB}) for each of the respective topologies can be estimated by multiplying the total component area (including the area of the FETs, gate drivers, and high-frequency capacitors) by a mass-to-area density factor and a space factor of 1.5 as the following:

$${M}_{PCB} \approx 1.5 \times {ρ}_{PCB} \times ( {A}_{tot} ) \qquad ( 1 )$$

where M_{PCB} is the estimated total PCB mass and Aₜₒₜ=A_{FETs}+A_{GDs}+A_{HF-Caps} is the total component area including the area of the FETs (A_{FETs}), gate drivers (A_{GDs}), and high-frequency capacitors (A_{HF-Caps}). In equation (1), a PCB mass-area density of ρ_{PCB}=0.9584×10⁻³ kg/cm² can be estimated as an upper limit (e.g., using a PCB weight estimator) by assuming a four-layer board and conservative PCB specifications, such as copper thickness of 140 μm (4-oz copper), 100% copper density and carrier thickness (FR4) of 2 mm.

The topology comparison can be performed with the 1200-V SiC MOSFET C3M0075120J. MOSFETs can be derated to 60% of the maximum device voltage in the full-bridge and three-phase bridge inverters, whereas they can be derated to 50% for the ANPC inverter to accommodate for non-idealities such as dc bus imbalance. For the ANPC inverter, the machine's number of series-connected turns per pole pair (and per phase) can be scaled appropriately to utilize the available voltage. For example, in the machine design in Table 2, the number of turns is scaled by a factor of V_{dc,3L}/V_{dc,2L}=1200/720 or equivalently the impedance is scaled by (1200/720)². Furthermore, it can be assumed that the same device technology (C3M0075120J) is used for both the low-frequency and high-frequency device pairs in the ANPC inverter.

The device total loss assumptions (conduction loss plus switching loss) are summarized as follows: For the device conduction loss, an on-state device resistance of R_{ds,on}|_{Tj=150° C.}=100mΩ at 150° C. maximum junction temperature ca used as a conservative assumption for a single (unit) device. The total device conduction loss for the three-phase ANPC inverter with delta-connected winding is similar to that of the full-bridge inverter as two devices carry the current at any time, assuming that the ANPC's low-frequency device uses the same device technology (i.e. C3M0075120J) and has the same semiconductor device area.

For the switching losses, the devices can be assumed to be hard-switched. The switching loss in one half-bridge over a switching cycle comprises the turn-on and turn-off losses in the active (positive-current-carrying) and freewheeling (negative-current-carrying) devices, and is generally dominated by the active device. The total switching loss in a half-bridge can be estimated as some factor between one and two times the active device switching loss (this factor is referred to herein as kₗ). For the topology comparison example provided herein, the switching loss in one half-bridge is assumed to be 2× the active device switching loss as a conservative assumption (the freewheeling device is assumed to have the same switching loss as the active device).

In one example, kₗ is measured to be 1.3 with the C3M0075120J switch after implementing the inverter hardware. Changing kₗ from 2 to 1.3 has a generally identical effect on all the considered inverter topologies and does not affect the outcome of the topology comparison. However, once an inverter topology is chosen, it may be beneficial for a designer to use a more accurate estimate of kₗ for a specific device and experimental setup. Doing so can yield a closer estimate of the minimum-loss number of devices per switch position for a given inverter topology.

To estimate the switching loss for a single device, one can use the average total switching energy loss<e_{sw,tot}(i_{ds}(t))|Vdc>over one fundamental line cycle. This involves scaling the switching energy loss curves provided in the device datasheet.

To account for the effect of junction temperature rise on the device switching loss, a temperature correction factor, k, can be applied (e.g., based on a device datasheet). In one example of k_{T}=E_{sw}|_{Tj=150° C.}/Esw|_{Tj=25° C.}=1.34. This factor corresponds to a maximum temperature rise of 125° C. from room temperature, which can be considered a conservative assumption. In contrast to the three-phase bridge and full-bridge inverters, the ANPC inverter has three devices connected to the output switching node at all times, leading to an additional C_{OSS} loss. As a result, an extra switching loss component (E_{OSS}) can be accounted for when analyzing the ANPC inverter.

The high-frequency dc link capacitors are responsible for filtering the high frequency component reflected on the dc bus voltage. The high frequency component is effectively equal to the device average switching frequency for the three-phase bridge inverter, while it is equal to the ripple frequency or twice the average device switching frequency for the full-bridge inverter and three-phase ANPC inverter. To size the high-frequency de bus capacitors and calculate the required area and weight, a 3% peak-to-peak dc bus voltage switching ripple can be considered.

In some embodiments, an inverter system may use multi-layer ceramic capacitors (MLC) capacitors, which provide high specific power and power density, low footprint area, high rms current ripple rating, high voltage rating, and low ohmic losses relative to other types of capacitors. In some examples, a ceramic capacitor B58035U9255M00 from the CERALINK series of TDK was selected and adopted for sizing the high-frequency capacitors in the topology comparison study.

Three-level carrier-based modulation schemes can be adopted in sizing the high-frequency de bus capacitors. This assumption corresponds to three-level line-line output voltage in the three-phase bridge and full-bridge inverters, and five-level line-line output voltage in the three-phase ANPC inverter. Therefore, the required capacitance per phase considering 50% duty ratio for maximum voltage ripple can be written as:

$${C}_{dc , HF} = \frac{{I}_{o}}{4 Δ {v}_{c , pp} {f}_{HF}} \qquad ( 2 )$$

Here, Iₒ is the fundamental peak line current for the three-phase bridge and three-phase ANPC inverters, whereas it is the fundamental peak output phase current for the full-bridge inverter. The frequency is given as f_{HF}=f_{SW} for the three-phase bridge inverter, whereas it is given as f_{HF}=fᵣᵢₚₚₗₑ=2f_{SW} for the full-bridge and three-phase ANPC inverters. Δv_{c,pp} is the maximum voltage ripple on the de bus, e.g., Δv_{c,pp}=3% V_{dc} for the example topology comparison in this paper. In the comparison, any low-frequency (e.g., twice-fundamental-frequency) ripple in the bus capacitors may be neglected. This pertains to the case of three single-phase inverters because it is assumed that a given set of three single-phase inverters has their dc bus inputs tightly coupled such that low-frequency pulsations cancel among the inverter inputs.

The three topologies can be compared under equal-phase-current rms ripple. Equivalent carrier-based pulse-width-modulation (PWM) schemes can be adopted to find the average device switching frequency required to achieve a specified percentage rms ripple in the machine phase-currents (i.e. 2.7%). Namely, (a) three-phase sine-triangle PWM can be used for the full-bridge drive and (b) a PWM with triangular carrier and one-sixth third-harmonic-injected references can be used for the three-phase bridge inverter with delta-connected winding (three-level switched output voltage). For the three-level ANPC inverter with delta-connected winding, (c) three-level phase disposition (PD) PWM with in-phase triangular carriers (above and below the reference zero point) and one-sixth third-harmonic-injected references can be used (five-level switched output voltage).

The device average switching frequency for the full-bridge and three-phase bridge inverters can be found analytically or by simulation. In one example, a simulation can be used to find the device average switching frequency for equal-phase-current rms ripple percentage in the respective inverter topologies. It is found that for 2.7% phase-current rms ripple the full-bridge drive requires 79.17 kHz, while the three-phase bridge inverter requires 129.17 kHz and the three-phase ANPC inverter requires 29.17 kHz. The required device average switching frequencies for each topology are summarized in Table 3.

TABLE 3
Required device average switching frequency for each of the respective
inverter topologies to achieve 2.7% phase-current rms ripple
for the 1-MW motor drive design (given in Table 2)

| | | Three-phase | |
|---|---|---|---|
| | Full-bridge | bridge | Three-level |
| | inverter | inverter | ANPC |
| Carrier ratio (f_{c}/fₒ) | 38 | 62 | 28 |
| Device switching | =38 × | =62 × | =14 × |
| frequency (f_{sw}) | fₒ = f_{c} = | fₒ = f_{c} = | fₒ = f_{c}/2 = |
| | 79.17 kHz | 129.17 kHz | 29.17 kHz |

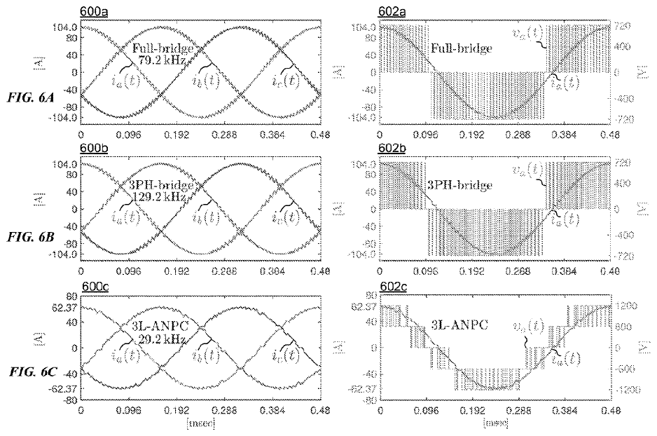

Turning to FIGS. 6A-C, a 100-kW three-phase set (one of the ten three-phase sets in the 1-MW drive) of each inverter topology can be simulated with the corresponding average device switching frequency (Table 3) with the machine parameters specified in Table 2.

FIG. 6A shows a simulated phase current waveform 600a and a phase-A voltage/current waveform 602a for the full-bridge inverter of FIG. 5A. FIG. 6B shows a simulated phase current waveform 600b and a phase-A voltage/current waveform 602b for the three-phase-bridge inverter of FIG. 5B. FIG. 6C shows a simulated phase current waveform 600c and a phase-A voltage/current waveform 602c for the three-phase ANPC inverter of FIG. 5C.

The simulated phase-current rms ripple percentages for the full-bridge inverter, three-phase bridge inverter, and three-phase ANPC inverter are 2.67%, 2.65%, and 2.73%, respectively, with device average switching frequencies of 79.2 kHz, 129 kHz, and 29.2 KHz, respectively. Thus, the simulated phase-current rms ripple percentage for all three topologies is ~2.7%. This confirms that the average device switching frequency for each of the considered inverter systems achieves the motor design specified rms current ripple percentage.

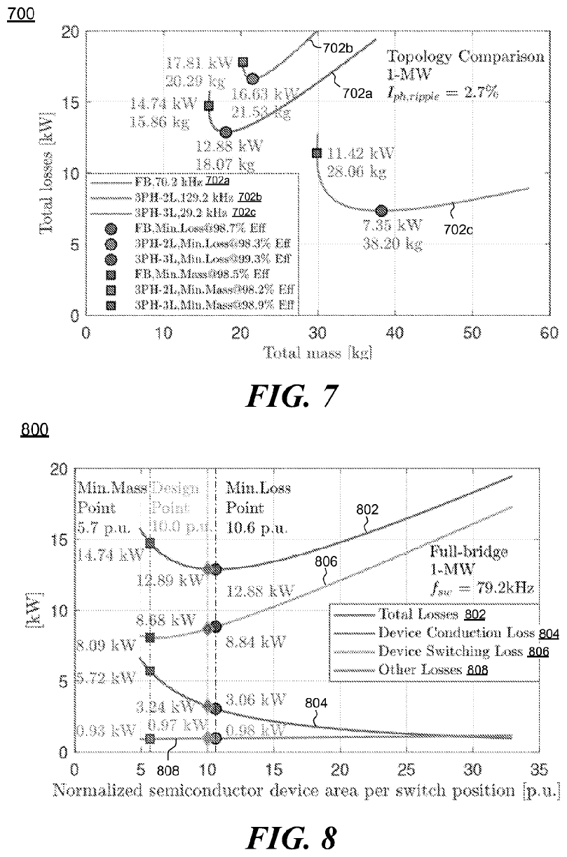

Turning to FIG. 7, in the efficiency-weight comparison, the total loss of the 1-MW inverters accounted for the total device loss (conduction and switching), high-frequency capacitor losses for a specified peak-peak dc bus voltage ripple, and the gate driver losses. The total weight, on the other hand, included the weight of FETs, gate drivers, heatsinks and the de bus high-frequency filtering capacitors. The total loss versus weight curves comparing the three different converters is shown in chart 700 of FIG. 7. In more detail, curve 702a corresponds to the full-bridge (FB) inverter of FIG. 5A, curve 702b corresponds to the three-phase bridge (3PH-2L) invert of FIG. 5B, and curve 702c corresponds to the three-phase three-level ANPC inverter of FIG. 5C.

As seen from FIG. 7, the multilevel drive is the most efficient as compared to the full-bridge and three-phase bridge drives; this is due to the reduced device switching frequency and thus switching losses for equal percent rms phase-current ripple. However, it is by far the heaviest in weight owing to the relatively large high-frequency bus capacitance required for equal dc voltage ripple. By contrast, a group of full-bridge inverters yields by far the lightest weight and the second-highest efficiency of the three options. Thus, in some embodiments, an inverter system be provided using the topology of FIG. 5A.

Turning to FIG. 8, with the selected 1-MW full-bridge inverter system in the above comparison, plots can be made of the total loss (comprising losses from device conduction, device switching, gate drivers and high-frequency de bus capacitors), and the individual loss components against the normalized semiconductor device area per switch position (equivalently, the total number of C3M0075120J devices per switch). In chart 800 of FIG. 8, curve 802 represents total loss, curve 804 represents device conduction loss, curve 806 represents device switching loss, and curve 808 corresponds to other losses. The minimum-loss (highest-efficiency) point, minimum-weight point, and the selected design point are also marked in the chart 800. Ten FETs per switch is selected as the design point for each single-phase inverter which is closer to the maximum-efficiency point than to the maximum-specific-power point to provide additional thermal device margin for the inverters. Of note, the furthest points to the left of the curves in FIGS. 7 and 8 represent the theoretical device thermal limits.

Turning to FIGS. 9A-C, as part of a co-optimization process, the device switching frequency can be swept between 20 kHz and 100 kHz in a co-optimization loop to identify the highest specific-power full-bridge-inverter-based motor drive design. As an example, a co-optimization process can identify an optimum device switching frequency of 80 kHz. The number of devices per switch can be chosen through an optimization process (e.g., as part of a co-optimization routine alongside the electric machine and thermal management subsystems) that minimized the total full-bridge inverter system loss as a function of the normalized semiconductor device area and device switching frequency. The number of devices per switch per single-phase inverter can be selected to be between the minimum-mass point and the minimum-loss point, closer to the maximum-efficiency point (i.e., 10 FETs per switch), to provide additional design thermal margin for the inverters (see FIG. 8).

FIGS. 9A and 9B illustrate a hardware implementation of a 33.3-kW single-phase full-bridge inverter board 900, with FIG. 9A showing a high-side FET view and FIG. 9B showing a low-side FET view. FIG. 9C shows a 100-kW full-bridge inverter set 940 comprising three comprising three of the full-bridge boards 900.

Each of the four (4) switch positions can be realized using ten (10) parallel FETs (e.g., based on the co-optimization results) for a total of forty (40) FETs. It should be understood that using ten (10) parallel FETs to implement a switch is merely illustrative and that a given switch position can be realized using more than or less than ten (10) parallel FETs. As shown, the forty (40) total FETs arranged in four rows of ten (10), with two rows on front side (FIG. 9A) corresponding to the high-side FETs in FIG. 5A (i.e., to switches Sₐ₁ and Sₐ₂) and two rows on the back side (FIG. 9B) corresponding to the low-side FETs in FIG. 5A (i.e., to switches S̅ₐ₁ and S̅ₐ₂). In some embodiments, the FETs may be 1200-V SiC devices (e.g., CREE C3M0075120J devices). FET 902 in FIG. 9A is representative, and comprises both the FET and a heatsink (HS). As can be best seen in FIG. 9C, metal heatsinks can be amounted onto the FETs (e.g., soldered to the FET tab).

In some embodiments, the high-side and low-side FETs of a single-phase board's half-bridge can be overlaid on the top and bottom sides of the board, respectively. This layout approach, as opposed to having the FETs on the same PCB plane, can minimize switching commutation loops, resulting in low switching over-voltage.

Each switch position comprising ten (10) FETs can be operated by a separate gate driver (GD) circuit, with a gate driver circuit comprising a single galvanically-isolated gate driver chip (e.g., isolated gate driver chip 906) driving ten (10) individual emitter-follower-gate drive chips (e.g., individual gate driver circuit 904, which may include a chip and ancillary components for example). The individual gate driver circuits for each FET, including the high-side FETs, can be located over copper planes which have the same voltage as the MOSFET's source pins (output phase copper trace for the high-side FET, and ground copper trace for the low-side FET). This approach can simplify driving the high-side FETs, eliminating the need for complicated gate driver circuitry, and ensures safe and reliable device operation.

To enhance signal integrity and reduce common-mode noise, a local controller (MCU) 926 can supply the gate signals for each board. In more detail, local controller 926 can send signals to the isolated gate driver chips, which in turn send signals to the individual gate driver circuitry. The individual gate driver circuitry for the high side switches can have a ground which changes from 0 volts to 720 volts, for example.

Inverter board 900 also includes a plurality of high-frequency (HF) capacitors and low-frequency (LF) capacitors. In the example shown, there are forty-four (44) HF capacitors, with HF capacitors 908 being representative, and there are five (5) LF capacitors, with LF capacitor 910 being representative. The LF capacitors filter the low-frequency components of the de bus voltage, including the twice fundamental-frequency component and fundamental-frequency component. The HF can be chosen to maximize the number of HF capacitors that could fit on the board. A higher number of HF capacitors increases the high-frequency capacitance across a half bridge (consisting of both high-side and low-side FETs), reducing the HF ripple, which is desirable. In some examples, forty-four (44) HF capacitors per single-phase full-bridge board yields a desired high-frequency dc bus voltage ripple per desired specification. In general, a lower, or larger number of capacitors may be used depending on the space available on the board, how that space is utilized, and/or to achieve a desired high-frequency voltage ripple. Note that in each full-bridge inverter board (FIG. 9A and FIG. 9B), the HF capacitors and LF capacitors are connected between the +DC and −DC terminals/copper planes.

As shown, the HF capacitors can be located close to where the FETs are for improved operation. In particular, one HF capacitor can be located between every FET in a row of ten (10) FETs and then one on the outside of the end FETs. That way each FET has a HF capacitor on both sides of it.

The LF capacitors can be connected between the +DC and −DC terminals/copper planes. The LF capacitors can be placed on either the top side of the board or the bottom side of the board, depending on what is appropriate in terms of available space. The LF capacitors can be larger in value (more capacitance) and can help to keep the supply constant for longer periods of time, compared to the HF capacitors. Of note, the LF capacitors may be located further from the FETs (e.g., mounted down the middle of the board as shown) compared to the HF capacitors (due to their use for maintaining constant supply over longer time periods) without affecting the overall switching performance of inverters (i.e., the switching performance and reliability of a half bridge in an inverter board).

Inverter board 900 also includes a plurality of dc bus interconnects 912 that extend from front to back of the board 900. As shown, each dc bus interconnect 912 may be positioned between a pair of LF capacitors. The de bus of the three full-bridge boards (FIG. 9C) can be tightly electrically coupled (through aluminum interconnect standoffs) to provide a low-impedance path for cancellation of twice-fundamental-frequency energy-pulsation components. The inverter's ac output fundamental frequency may sometimes be referred to as “machine frequency.” Each full-bridge inverter board 900 has a dc port 928 that can connect both to the de bus rings via two leads, as previously discussed, and neighbor board(s). Of note, the total power delivered by one set of three (3) boards can be approximately constant over time. At any point in time, one board may be putting out more power than another, but the total is the same. By connecting the three boards together, the LF capacitors (e.g., 15 total LF capacitors) on all three boards can be used to help hold the bus voltage constant.

The dc inputs of the three boards can be tightly coupled, meaning connected together with low inductance (e.g., less than or equal to a couple nano Henries). The dc bus interconnects (e.g., 4 aluminum stand-off spacers) provide low inductance connections between the dc bus input of each single-phase full bridge inverter board in a 3-phase set.

A pair of isolated supplies 914, 916 can be provided on the front side of the board (FIG. 9A), for example. In some examples, a first isolated supply 916 can be a 9-36 V to 12 V supply and a second isolated supply 914 can be a 12 V to +15/−5 V supply. The first isolated supply 916 accepts a standard 24 V (with a range of 9 V to 36 V) from an external dc supply and outputs a 12 V supply, providing galvanic isolation between the external dc supply and the control circuitry (microcontroller and its ancillary circuit). The second isolated supply 914 takes the 12 V and outputs isolated +15 V and −5 V supplies required by the gate drive circuitry, providing galvanic isolation between the control circuitry and the gate drive circuitry. The isolated supplies are used to power the gate drive circuits/chips. Because the ground of the gate drivers is not the same as the ground for the local controller (MCU), an isolated supply is needed.

Isolated supply 916 can provide isolated power for the local controller 926, among other circuitry. It is appreciated herein the local controller 926 ground may be located close to the V_{dc}-supply so one may consider tying them together. However the V_{dc}-bus ring has over 1000 amps of current flowing in it. If that caused a voltage change of a few volts (e.g., 1 or 2 volts), it would not be significant compared to 720 V but it would be very significant compared to the 5 V that the local controller 926 uses. Providing this isolated supply allows us to use a separate 24 V supply to provide power to all the inverter local controllers without worrying about any voltage drops on the bus rings.

Inverter board 900 also includes a current sensor 918 which can be provided on the front side of the board (FIG. 9A), for example. Current sensor 918 is used to measure the current in the motor winding and can be connected to the local controller 926. Current sensor 918 can be used to make sure the required current is flowing in the motor winding. It can also be used for overcurrent protection. If current measured using sensor 918 is higher than expected, the FETs can all be turned off and the inverter shut down, for example.

A universal asynchronous receiver/transmitter (UART) 920 can be provided for each inverter board, and used to transmit inverter board status information such as FET temperatures and dc bus voltage. UART 920 can be used for low speed (e.g., once per second) command and data transfer with a master controller (discussed below).

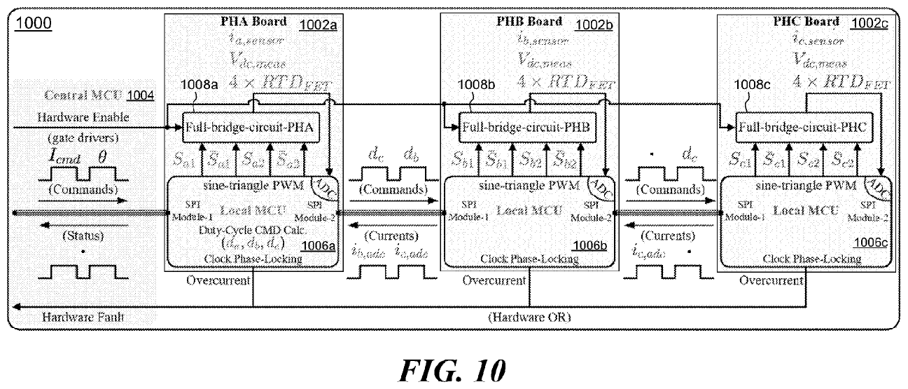

Inverter board 900 also includes a pair of serial peripheral interfaces (SPIs) 922 and 924 that can be used to connect the three boards in a set in a daisy-chain configuration. SPI 922 may be isolated using a highspeed digital isolator 925. In a set of three boards, the first board may have its isolated SPI 922 connected to a master controller board, the second board may have its isolated SPI 922 connected to SPI 924 of the first board, and the third board may have its isolated SPI 922 connected to SPI 924 of the second board, such as illustrated in FIG. 10.

Inverter board 900 also includes local controller 926 or MCU. Local controller 926 can supply the gate signals for the board 900, e.g., using a carrier-based pulse-width-modulation (PWM) scheme. In some examples, local controller 926 may be a dsPIC33EV64GM006 digital signal controller (DSC) from MICROCHIP. In some examples, local controller 926 can run with an instruction cycle rate of F_{CY}≈60 MHz (60 MIPS).

A dc input port 928 and an ac output port 930 can be provided on the front-side of the board (FIG. 9A) for example. The de input port 928 can be connected via short leads to a pair of de bus rings (positive and negative) located underneath all inverter boards in the inverter system. The ac output port 930 can be connected to drive a single-phase stator winding. As previously discussed, a stator can have multiple sectors each comprising three separate (open-ended) single-phase windings. Thus, three ac ports provided by inverter set 940 (FIG. 9C) be connected drive one sector of the stator.

In some embodiments, one or more of the key components of the 33.3-kW full-bridge board 900 can be selected according to Table 4.

TABLE 4
Key components of of each of the 30 33.3-kW full-bridge boards

| Comp. | MOSFET | Gate Driver | HF Capacitor | LF Capacitor | Heatsink |
|---|---|---|---|---|---|
| Part no. | C3M0075120J | UCC21750DW | B58031U9254M062 | C4AQQLW4500A33J | 7106DG |
| | | (per switch), | | | |
| | | ZXGD3006E6 | | | |
| | | QTA (emitter | | | |
| | | follower per | | | |
| | | FET) | | | |
| Qty per | x40 | x4 | x44 | x5 | x40 |
| 1-phase | | x40 | | | |
| inverter | | | | | |

It is appreciated that the FETs that are farthest from the cooling source have the highest operating junction temperatures. Thus, temperature sensors (e.g., resistance temperature detectors, RTDs) can be affixed (e.g., glued with low thermal-resistance epoxy) to the heatsinks of the four devices farthest from the cooling source as seen in FIGS. 9A-C. Temperature sensor 932 in FIG. 9A is illustrative.

In addition to the per-FET heatsinks previously discussed, an inverter board can include additional heatsinks such as under temperature sensor 932. The various heatsinks can be used for air cooling, resulting in a significantly lighter weight system compared to one using water cooling.

The mass of the inverter set as seen in FIG. 9C (including the input and output connectors which are not shown in the figure) may be approximately 1.87 kg. The mass of the enclosure may be approximately 1.837 kg, whereas the mass of the cooling fans may be approximately 0.777 kg.

FIG. 10 illustrates overall control of a full-bridge inverter set. A simplified system 1000 includes three single-phase full-bridge inverter board 1002a-c and a master controller board 1004 (providing so-called “master control”). The three inverter boards 1002a-c (which may be referred to as the phase A-C boards, respectively), each include a respective local MCU 1006a-c and full-bridge circuit 1008a-c. The inverter boards 1002a-c may each be the same as or similar to board 900 of FIGS. 9A and 9B. The set of boards 1002a-c may be the same as or similar to inverter set 940 of FIG. 9C.

The general concepts, structures, and techniques described herein can be used to provide an inverter system having multiple sets of inverter boards (e.g., 10 sets) connected to a single master controller.

Illustrative system 1000 can employ a three-level carrier-based modulation scheme. Each set of three single-phase boards can be run in open-loop voltage control or closed-loop current control with the encoder angle and current or voltage commands received from a master controller board 1004 via an isolated serial-peripheral-interface (SPI) communication. The duty cycle commands can be calculated on the phase-A local controller, and the boards are connected in a daisy-chain configuration using an isolated SPI.

The SPI interface can be used to transfer the phase currents and PWM commands among the boards to allow closed-loop d-q current control to be used with each set of three single-phase boards. The SPI communication also facilitates synchronization of the boards to a single encoder signal and current or voltage command. Moreover, phase-locking of the central unit processors' (CPUs′) clocks on the different inverter boards to the phase-A board 1002a has been implemented (phase-locking of clocks of multiple boards to a board, or to a master reference will be implemented when operating multiple inverter sets in a complete inverter system). Each board includes over-current protection, temperature monitoring of the four hottest FETs, and de bus voltage monitoring.

Additional details of control of one inverter set are provided next.

Duty cycle commands (PWM sinusoidal voltage reference waveforms compared with triangular carrier) can be calculated on the phase-A local controller, and the boards can be connected in a daisy-chain configuration using an isolated SPI. This interface is used to transfer the phase currents and PWM commands among the boards to allow closed-loop d-q current control to be used with each set of three single-phase boards. The SPI communication also facilitates synchronization of the boards to a single encoder signal and current or voltage command. Moreover, phase-locking of the central unit processors' (CPUs′) clocks on the different inverter boards to a master reference (i.e., master controller) is also implemented when operating multiple inverters sets synchronously. Each board includes over-current protection, temperature monitoring of the four furthest FETs from the air-cooling source (i.e., hottest FETs), and de bus voltage monitoring.

The ten 100-kW sets in the 1-MW machine drive can operate in both open-loop and closed-loop modes, utilizing SPI amplitude and angle commands from the master controller. In open-loop mode, the amplitude is interpreted as a voltage command, while in closed-loop mode, it is seen as a current command. Sine lookup tables can be used in the generation of duty cycle reference waveforms for both modes. In open-loop mode, the modulating reference waveforms dₐ, d_{b}, d_{c} are calculated by multiplying the modulation gain with sine/cosine lookup table values, where the modulation gain is the product of the modulation index and the number of PWM counts in a 12.5 μs period. In some cases, the table is a 512×3 matrix with the number of rows representing the length (sampling resolution) of the table and the columns corresponding to the individual phases' reference waveforms. The duty cycle waveform calculation, including accessing the sine lookup table, can be performed at every PWM interrupt to provide 40 updates per line cycle at a 2 kHz machine fundamental frequency and an 80 kHz carrier frequency, for example. However, this table may be longer than 40 points to generate the PWM duty cycle commands for a wide range of fundamental frequencies starting from a fraction of Hz (nearly standstill) to 2083 Hz at rated speed, to enable variable-speed testing of the machine drive. In some cases, longer tables can extend resolution for lower frequencies below 156 Hz (i.e., frequency resulting in sampling 512 points from the lookup table at an 80 kHz carrier frequency), but the gains in resolution beyond 156 Hz become redundant and unnecessarily consume program memory, not to mention-that we are mostly interested in testing the machine at high speed, and eventually at full speed/rated conditions. The same sine lookup tables can be employed for calculating duty cycle references in closed-loop current control.

The commonly used synchronous reference frame d-q current control technique, well-known for its simplicity and efficacy, can be employed within each full-bridge three-phase set to regulate phase currents. The initial stage of full system testing focuses on operating the machine at steady-state conditions achieving full power (e.g., 1-MW) and rated speed (e.g., 12500 rpm) to assess performance metrics including specific power (mechanical shaft power by the total weight of one machine drive), component losses of the different subsystems, efficiency, cooling capabilities, rotor dynamics, and reliability. The objective of the current phase of the project is not to investigate the drive dynamics, such as the maximum acceleration rate to get to rated speed safely (without compromising the machine), but to ascertain its steady-state performance at rated power and torque, verify cooling requirements, and compare/correlate experimental results with model predictions (as well as adjust models and constraints based on learnings). Consequently, integral control can be utilized in the d-q domain for its ability to ensure smooth step responses and reasonable settling times, reserving proportional-integral control and other high-performing control strategies (e.g. feed-forward control) for future exploration in subsequent project phases.

The phase-A board receives angle (θ) and current command (I_{cmd}) from the master controller, with θ generated from an absolute encoder via SPI. This angle (after some processing in the master controller), alongside I_{cmd}, is distributed to the phase-A boards of all ten (10) inverter sets through the multiplexer board. Internally, during inductive load tests without the machine and encoder, the master controller generates ωt using a timer. The abc-domain phase currents can be transformed to the d-q rotating reference frame, comparing i_{d} and i_{q} with their references, integrating the errors e_{d} and e_{q} using gains K_{l,d} and K_{l,q}. The computed control signals v_{d,ref} and v_{q,ref} can then be inverse transformed to the abc domain. Another form of the inverse transformation that requires less computations is to rotate v_{q} as to align it with vₐ, thus forcing vₐ to zero. This can be achieved by adding the integral action of the d-axis error to the encoder angle, wherein the d-axis integrated error becomes proportional to some offset or correction angle called θ_{c}, and using this angle to offset/correct the encoder angle (θ=θ_{enc}+θ_{c}). These inner-loop control calculations can be executed, for example, within the PWM interrupt's ISR, occurring 40 times per 2 kHz fundamental frequency at an 80 kHz carrier frequency. Sine lookup tables can be utilized for abc-dq transformations, with the measured d-q currents and duty cycle reference voltages (dₐ=V_{a,ref}, d_{b}=v_{b,ref}, d_{c}=v_{c,ref}) derived from these transformations.

The phase-A board receives an angle (θ) and a current command (I_{cmd}) from the master controller, with θ sourced from an absolute encoder via SPI. After processing the raw encoder data, the motor angle (θ_{enc}), along with I_{cmd}, is distributed to the phase-A boards of all ten (10) inverter sets via the multiplexer board. Internally, the master controller can generate ωt using a timer during inductive load tests without the machine and encoder. Phase currents in the abc-domain can be transformed to the d-q rotating frame, comparing i_{d} and i_{q} with their references, and integrating the errors e_{d} and e_{q} using gains K_{l,d} and I_{l,q}. The resultant control signals v_{d,ref} and v_{q,ref} can then be inverse-transformed to the abc domain. A computationally efficient inverse transformation aligns v_{q} with vₐ and nullifies v_{d}, achieved by adjusting the encoder angle (θ=θ_{enc}+θ_{c}) with a correction angle θ_{c}, derived from integrating the d-axis error. This approach can be computed, for example, within the PWM interrupt's ISR, occurring 40 times for a 2 kHz fundamental frequency at an 80 kHz carrier frequency, utilizing sine lookup tables for the abc-to-dq and dq-to-abc transformations, to compute the duty cycle reference voltages (dₐ=v_{a,ref}, d_{b}=v_{b,ref}, d_{c}=v_{c,ref}).

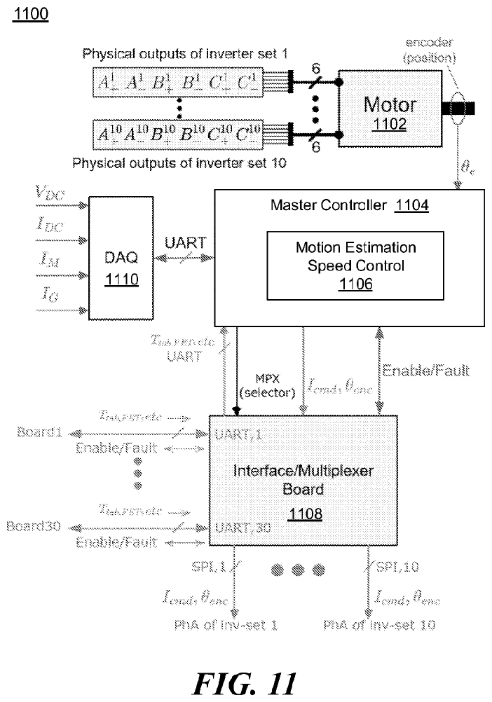

Turning to FIG. 11, next described is an overview of the overall control architecture of a 1-MW machine. Detailed herein are the primary components that instrument and manage each 1-MW machine drive, beginning with a master controller responsible for speed and torque management. This master controller dispatches command and control signals via an interface-multiplexer board to all inverter sets (slaves), which locally execute inner loop current control, monitor tasks such as FET temperatures, and manage control actions like enabling or disabling inverters in case of an overcurrent fault. Further described are the routing of signals from the master controller to all thirty (30) boards in a machine drive, considerations for signal integrity, noise mitigation, and the synchronization of all inverter boards to the master.

Illustrative control architecture 1100 of FIG. 11 includes a motor 1102, a master controller 1104 providing motion estimation and speed control 1106, an interface-multiplexer board 1108, and data acquisition (DAQ) system 1110.

As shown in the example of FIG. 11, master controller 1104 utilizes encoder angles θ_{enc} and torque measurements τₘₑₐₛ for motor and generator control. It sends angle and amplitude commands to inverter sets via high-speed serial-peripheral-interface (SPI), operating at a given frequency (e.g., 15-MHz), where the amplitude signal is interpreted as voltage in open-loop, or current in closed-loop mode. Commands (I_{cmd}, θ_{cmd}) are distributed to all ten (10) inverter sets within a 1-MW drive by interface-multiplexer board 1108, positioned in close proximity to the inverter sets. The master controller 1104 can also monitor FET temperatures and d_{c} bus voltages through universal asynchronous receiver/transmitter (UART), which is slower than SPI (medium speed), with a baud rate of approximately 1 MHz (921600 baud rate).

A hardware enable/fault line is interfaced between the master controller 1104 and each inverter board via the multiplexer board 1108. The master controller 1104 can be equipped with a relay to enable the on/off trigger of the dc power supply (e.g., 150-kW dc power supply). This can be done to facilitate an emergency stop or shutdown option from the master controller. DC voltage and current (V_{DC}, I_{DC}) measured by transducers at the output terminals of the dc power supply which supplies the system losses at steady state, are monitored by DAQ system 1110. In some cases, DAQ system 1110 may be a NATIONAL INSTRUMENTS DAQ system. The data can also be communicated to the master controller 1104 via UART.

Concurrently, current transducers at each drive input can measure and monitor the total de current for each machine drive (I_{M} dc input current for the motor drive, and I_{G} for the generator drive).

In some embodiments, the master controller board, positioned in the center, connects via three twisted-pair Ethernet cables to each multiplexer board, for both motor and generator sides. The connections include: (a) SPI for command signals, (b) UART for logging temperatures, dc bus voltages, and status data, and (c) MPX for board selection for monitoring or debugging. Differential line transceivers can be provided to strengthen signal integrity, with impedance-matched termination. The UART encompasses a hardware enable/reset line and an overcurrent fault line (in addition to TX and RX lines), distributing enable signals to each board and aggregating board fault lines via thirty (30) cascaded OR logic chain on the multiplexer board, producing a singular fault signal transmitted back to the master controller.

In some embodiments, the system's hardware can include an encoder, such as a RESOLUTE READHEAD and RESA RING from RENISHAW, employing a bidirectional synchronous serial (BiSS) protocol for high-precision position data acquisition in a master-slave configuration. In some examples, the encoder may have an 18-bit resolution, extending to 28 bits per cycle for enhanced data integrity. The encoder interfaces through differential pairs for signal transmission and synchronization. Additionally, a rotary torque transducer (e.g., an AxialTQ rotary torque transducer), mounted on the shaft, can provide torque measurements in analog and digital formats. The transducer can feature three galvanically isolated output channels, and integrate with the master controller and an NI data acquisition system for comprehensive control and monitoring.

In some embodiments, the master controller (which may be provided as a MICROCHIP dsPIC33EP512GM310, for example) can employ an external crystal oscillator instead of the internal FRC oscillator used in the inverter boards to ensure accurate and consistent torque measurement. The master controller can use the torque transducer's frequency output channel and measures the square wave's period and frequency, which is proportional to the torque. The crystal oscillator's better tolerance and lower temperature drift compared to the processor's internal FRC ensure consistent torque measurement and increase torque accuracy.

In some embodiments, one or more noise mitigation measures can be taken at the design stage of the inverter boards and overall control system. For example, one or more of the following measures/techniques may be used:
Per-FET gate drive circuits are placed over copper planes that are at the same voltage as the FET source leads;
A local processor (dsPIC33EV64GM006) provides the gate signals for the board;
The selected processor has a +5-V supply for improved noise margin;
The power supply for the processor is isolated from the high-power bus;
The control and monitoring connections to the board are galvanically isolated from the high-power bus and the supply for the local processor. These input connections include a high-speed SPI link (15 MHz), a medium speed UART link (921600 baud, hence ~1 MHz), a hardware enable line, a hardware fault line, and a 24-V logic power supply input;
Parity checking is used on all SPI commands;
A multiplexer board is used to distribute command signals to all the inverters. It is located in close proximity to the inverters and is connected to them with short cables. The control ground of each inverter is isolated from the ground of the multiplexer board;
The multiplexer board is connected to the master controller with distance between them that may be several meters. All signaling between the master controller and the multiplexer is transmitted/received with differential signals over twisted-pair wires, which are terminated with the characteristic impedance of the twisted pair (120Ω); and
The master controller is connected to the data logging computer with fiber optic cables.

In some embodiments, for each set of three full-bridge inverters, the designated phase A board performs the duty cycle reference generation for itself and the subsequent boards, phases B and C. It receives an angle and an amplitude (interpreted as voltage or current, based on mode of operation) via SPI, then directs commands to phase B, which forwards them to phase C. Simultaneously, measured currents from each board are relayed back to the phase A board. This continuous loop of command transfer and current exchange occurs every PWM cycle (e.g., 12.5 μs).

In some embodiments, each phase can be interconnected via an SPI interface, comprised of four signals: slave select (SS) (sometimes referred to as chip select, CS), serial clock (SCK), serial data out (SDO), and serial data in (SDI). During each PWM period, two 16-bit words can be exchanged through this interface, initiated by a high-to-low transition of the SS signal and concluded with its low-to-high transition. Boards can either generate a new SS for the subsequent phase or forward the received SS, facilitated by a single pole double throw (SPDT) switch. This setup directs the SS and SCK signals from left to right, while enabling bi-directional data transmission between SDO and SDI, effectively illustrating the data flow within the system.

As the internal fast RC (FRC) oscillator of the local controller is used one each board, which is prone to slight variations due to clock tolerance, temperature drift, and voltage variations, the phase-B and phase-C boards' duty cycles uploaded to their PWM registers may tend to have errors. For instance, the phase-A board generates the PWM commands for itself and the other phases; thus, if there are variations in clock frequencies among the processors on different boards of an inverter set, there might be discrepancies in the PWM commands loaded into the phase-B and phase-C PWM hardware. For example, if the clock of the phase-A board, responsible for generating the PWM duty ratios for one fundamental cycle, was higher than that of the phase-B board, phase-B may skip some duty cycle values of uploaded on its PWM hardware, and if it was lower, phase-B would duplicate some values. Therefore, in some embodiments, a synchronization algorithm may be implemented on each inverter board to avoid such discrepancies and ensure all inverter boards' CPUs are synchronized to the master controller for proper operation.

This synchronization can be achieved by implementing oscillator clock frequency-locked and phase-locked loops on each inverter board. The local controller (processor) used in the inverter can be provided having a special register (sometimes referred to as the FRC oscillator tuning register or OSCTUN) enabling the tuning of the internal FRC oscillator frequency over a given range (e.g., ±1.5% of 7.37 MHz) to compensate for temperature, voltage variations, and manufacturing differences. This feature can be employed to implement a phase-locked loop (PLL) mechanism for synchronizing the frequency of the slave clocks to the frequency of the master.

In some embodiments, a hardware timer (e.g., TMR2) can be configured to count for one PWM interval (e.g., 12.5 μs or 80 kHz carrier frequency), thus counting from zero to a maximum value (e.g., 1472) before restarting (e.g., approximately 58.9 million-instruction cycle per second (MIPS) or ≈117.8 MHz of system clock frequency). The trailing edge (high to low transition) of the chip select signal can be employed as the synchronization signal, occurring precisely once per PWM interval. A designated service routine for an external interrupt on each processor can be triggered by the chip select (trailing edge). This chip-select-phase-locking signal is distributed via hardware using SPDT switches integrated on the boards, rather than being regenerated by software for precise locking (avoiding delays). With full system control for operating multiple inverter sets with the master controller and multiplexer boards, all the inverter processors are desirably phase-locked with the master control clock, enabling virtually identical phase locking code to be executed on all processors.

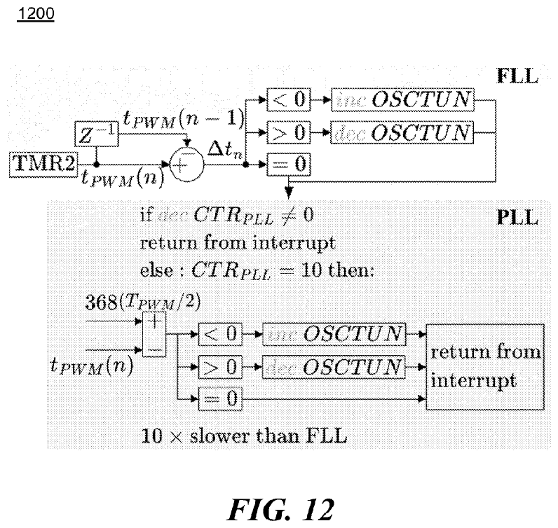

Turning to FIG. 12, a phase-locked loop (PLL) routine 1200 can be implemented on every inverter board to synchronize their local controller with the master controller. The synchronization interrupt routine can be initiated by a hardware chip select from the master controller, which activates the FLL, solely adjusting the clock frequency. The FLL algorithm can begin by comparing the timer-2 counter (t_{pwm}) to its previous value (which may count from 0 to 1472, corresponding to the number of clock pulses in the 12.5 μs PWM period). If the difference is nonzero, it increments or decrements the OSCTUN register (by ±1) based on whether the clock frequency is slower (negative difference) or faster (positive difference) than nominal, respectively, aiming to lock the clock frequency to its nominal value, and then it enters the PLL routine. If the timer-2 counter value equals its previous value, it directly initiates the PLL routine to check and correct the phase.

The PLL routine 1200 first examines the PLL counter; if it is nonzero, it is premature for phase checking, and the routine exits the interrupt to continue executing the software until the next iteration. If the PLL counter has elapsed (zero), it is reset to ten (10), and the current value of the timer-2 counter is compared to half of the PWM period (e.g., 368) to lock the phase of the individual board's PWM hardware to the midpoint of the switching period. Another point can be chosen, but halfway through the switching period compared to the beginning or end of the PWM counter waveform, may be selected to avoid glitches and to maintain consistency in the phase-locked loop behavior.

Once the PLL counter is reset, similar to the FLL, the OSCTUN register is incremented or decremented in the PLL routine based on the polarity of the difference between midpoint the switching cycle and the current t_{pwm} (368−t_{PWM}(n)), and if the difference is zero, the interrupt service routine is terminated. Therefore, the PLL can operate at a reduced rate (e.g., one-tenth of the FLL), controlled by the CTR_{PLL} countdown, to ensure precise phase synchronization at a specified point within the PWM cycle. CTR_{PLL} can be initialized to 256 only at the start of the program to enable frequency locking among the boards in a set before engaging the PLL as a startup condition.

As used herein, the terms “processor” and “controller” are used to describe electronic circuitry that performs a function, an operation, or a sequence of operations. The function, operation, or sequence of operations can be hard coded into the electronic circuit or soft coded by way of instructions held in a memory device. The function, operation, or sequence of operations can be performed using digital values or using analog signals. In some embodiments, the processor or controller can be embodied in an application specific integrated circuit (ASIC), which can be an analog ASIC or a digital ASIC, in a microprocessor with associated program memory, in a digital signal processor (DSP), and/or in a discrete electronic circuit, which can be analog or digital. A processor or controller can include internal processors or modules that perform portions of the function, operation, or sequence of operations. Similarly, a module can include internal processors or internal modules that perform portions of the function, operation, or sequence of operations of the module. A single processor or other unit may fulfill the functions of several means recited in the claims.

As used in the claims or elsewhere herein, the term “comprising” does not exclude other elements or steps, and the indefinite article “a” or “an” does not exclude a plurality.

As used herein, the term “predetermined,” when referring to a value or signal, is used to refer to a value or signal that is set, or fixed, in the factory at the time of manufacture, or by external means, e.g., programming, thereafter. As used herein, the term “determined,” when referring to a value or signal, is used to refer to a value or signal that is identified by a circuit during operation, after manufacture.

While electronic circuits shown in figures herein may be shown in the form of analog blocks or digital blocks, it will be understood that the analog blocks can be replaced by digital blocks that perform the same or similar functions and the digital blocks can be replaced by analog blocks that perform the same or similar functions. Analog-to-digital or digital-to-analog conversions may not be explicitly shown in the figures but should be understood.

Various embodiments of the concepts systems and techniques are described herein with reference to the related drawings. Alternative embodiments can be devised without departing from the scope of the described concepts. It is noted that various connections and positional relationships (e.g., over, below, adjacent, etc.) are set forth between elements in the claims, detailed description, and drawings. These connections and/or positional relationships, unless specified otherwise, can be direct or indirect, and the claimed inventions are not intended to be limiting in this respect. Accordingly, a coupling/connection of entities can refer to either a direct or an indirect coupling/connection, and a positional relationship between entities can be a direct or indirect positional relationship. As an example of an indirect positional relationship, references in the present description to element or structure A coupled/connected to element or structure B include situations in which one or more intermediate elements or structures (e.g., element C) is provided between elements A and B regardless of whether the characteristics and functionalities of elements A and/or B are substantially changed by the intermediate element(s).

Furthermore, it should be appreciated that relative, directional or reference terms (e.g. such as “above,” “below,” “left,” “right,” “top,” “bottom,” “vertical,” “horizontal,” “front,” “back,” “rearward,” “forward,” etc.) and derivatives thereof are used only to promote clarity in the description of the figures. Such terms are not intended as, and should not be construed as, limiting. Such terms may simply be used to facilitate discussion of the drawings and may be used, where applicable, to promote clarity of description when dealing with relative relationships, particularly with respect to the illustrated embodiments. Such terms are not, however, intended to imply absolute relationships, positions, and/or orientations. For example, with respect to an object or structure, an “upper” or “top” surface can become a “lower” or “bottom” surface simply by turning the object over. Nevertheless, it is still the same surface and the object remains the same.

The terms “disposed over,” “overlying,” “atop,” “on top,” “positioned on” or “positioned atop” mean that a first element, such as a first structure, is present on a second element, such as a second structure, where intervening elements or structures (such as an interface structure) may or may not be present between the first element and the second element. The term “direct contact” means that a first element, such as a first structure, and a second element, such as a second structure, are connected without any intermediary elements or structures between the interface of the two elements. The term “connection” can include an indirect connection and a direct connection.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within =2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described in connection knowledge of one skilled in the art to affect such feature, structure, or characteristic in connection with other embodiments whether or not explicitly described.

The disclosed subject matter is not limited in its application to the details of construction and to the arrangements of the components set forth in the detailed description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

Other variations to the disclosed embodiments can be understood and effected by those skilled in the art in practicing the claimed invention, from a study of the drawings, the disclosure, and the appended claims.

The mere fact that certain measures are recited in mutually different dependent claims does not indicate that a combination of these measures cannot be used to obtain an advantage.

Any reference signs in the claims should not be construed as limiting the scope.

All publications and references cited herein are expressly incorporated herein by reference in their entirety.

1. An inverter system for a high-power three-phase electric machine comprising:
a plurality of inverter sets each having three single-phase full-bridge inverters and configured to drive a three-phase set of open-ended phase windings of the electric machine.

2. The inverter system of claim 1 wherein the electric machine comprises a 1-MW motor.

3. The inverter system of claim 1 wherein, for at least one of the plurality of inverter sets, the three single-phase full-bridge inverters have a de bus tightly electrically coupled to provide cancellation of twice-machine-frequency energy pulsation.

4. The inverter system of claim 1 wherein the inverter sets are distributed along a circumference of the electrical machine.

5. The inverter system of claim 4 wherein each inverter of each of the plurality of inverter sets has ac output arranged to be connected to a separate one of the open-ended phase windings of the electric machine using a pair of terminal leads, wherein all said terminal leads are approximately of equal length.

6. The inverter system of claim 5 wherein the equal length of all said terminal leads is between six (6) and eight (8) inches.

7. The inverter system of claim 5 wherein each of the inverter sets is configured to connect to the electric machine along a coaxial direction.

8. The inverter system of claim 7 wherein the inverter sets are arranged to permit air flow in the coaxial direction.

9. The inverter system of claim 1 wherein, for at least one of the plurality of inverter sets, the three single-phase full-bridge inverters each have local processors with phase-locked clocks.

10. The inverter system of claim 9 wherein the clocks of the three single-phase full-bridge inverters are phase-locked with each other.

11. The inverter system of claim 9 further comprising a master controller configured to control each of the plurality of inverter sets, wherein the clocks are phase-locked with the master controller.

12. The inverter system of claim 11 further comprising an interconnect-multiplexer board configured to provide communication between the master controller and particular ones of the plurality of inverter sets.

13. The inverter system of claim 1 wherein at least one of the inverter sets has its three single-phase full-bridge inverters connected in a daisy-chain arrangement using serial-peripheral interface (SPI).

14. The inverter system of claim 1 wherein the electric machine has a stator with a plurality of sectors, wherein different ones of the plurality of inverter sets are configured to drive different one of the plurality of stator sectors.

15. The inverter system of claim 1 wherein at least one of the single-phase full-bridge inverters comprises a plurality of field-effect transistors (FETs) and a corresponding plurality of gate driver circuits.

16. The inverter system of claim 15 wherein each of the gate drivers is located over a copper plane having the same voltage as source pins of a respective one of the plurality of FETs.

17. The inverter system of claim 15 wherein the plurality FETs are arranged in a double-sided layout, with high-side and low-side FETs placed on opposite sides of a printed circuit board.

18. The inverter system of claim 15 wherein the at least one of the single-phase full-bridge inverters includes one or more temperature sensors attached to one or more FETs of the plurality.

19. The inverter system of claim 1 further comprising a dc bus ring to provide dc supply to the plurality of inverter sets.

20. An inverter set for a high-power three-phase motor comprising:
three single-phase full-bridge inverters configured to drive a three-phase set of open-ended phase windings of the motor, the three single-phase inverters have a dc bus tightly electrically coupled to provide cancellation of twice-fundamental-frequency energy pulsation.
